(19) United States
(12) Patent Application Publication
(10) Pub. No.: US 2013/0093899 A1
(43) Pub. Date: Apr. 18, 2013

(54) METHOD AND APPARATUS FOR MEDIA CONTENT EXTRACTION

(71) Applicants: Igor Danilo Diego Curcio, Tampere (FI); Sujeet Shyamsundar Mate, Tampere (FI); Francesco Cricri, Tampere (FI); Kostadin Dabov, Tampere (FI)

(72) Inventors: Igor Danilo Diego Curcio, Tampere (FI); Sujeet Shyamsundar Mate, Tampere (FI); Francesco Cricri, Tampere (FI); Kostadin Dabov, Tampere (FI)

(73) Assignee: NOKIA CORPORATION, Espoo (FI)

(21) Appl. No.: 13/275,833

(22) Filed: Oct. 18, 2011

(51) Int. Cl. H04N 7/18; G06F 17/30

(52) U.S. Cl. 348/159; 707/737; 707/E17.089; 348/E07.085

(57) ABSTRACT

Various methods are provided for analyzing media content. One example method may include extracting media content data and sensor data from a plurality of media content, wherein the sensor data comprises a plurality of data modalities. The method may also include classifying the extracted media content data and the sensor data. The method may further include determining an event-type classification based on the classified extracted media content data and the sensor data.

### TECHNOLOGICAL FIELD

Embodiments of the present invention relate generally to media content and, more particularly, relate to a method, apparatus, and computer program product for extracting information from media content.

### BACKGROUND

At public events, such as concerts, theater performances and/or sports, it is increasingly popular for users to capture these public events using a camera and then store the captured events as media content, such as an image, a video, an audio recording and/or the like. Media content is even more frequently captured by a camera or other image capturing device attached to a mobile terminal. However due to the large quantity of public events and the large number of mobile terminals, a large amount of media content goes unclassified and are never matched to a particular event type. Further, even in instances in which a media content event is linked to a public event, a plurality of media content may not be properly linked even though they captured the same public event.

### BRIEF SUMMARY

A method, apparatus and computer program product are therefore provided according to an example embodiment of the present invention to analyze different aspects of a public event captured by a plurality of cameras (e.g. image capture device; video recorder and/or the like) and stored as media content. Sensor (e.g. multimodal) data, including but not limited to, data captured by a visual sensor, an audio sensor, a compass, an accelerometer, a gyroscope and/or a global positioning system receiver and stored as media content and/or received through other means may be used to determine an event-type classification of the public event. The method, apparatus and computer program product according to an example embodiment may also be configured to determine a mashup line for the plurality of captured media content so as to enable the creation of a mashup (e.g. compilation, remix, real-time video editing as for performing directing of TV programs or the like) of the plurality of media content.

One example method may include extracting media content data and sensor data from a plurality of media content, wherein the sensor data comprises a plurality of data modalities. The method may also include classifying the extracted media content data and the sensor data. The method may further include determining an event-type classification based on the classified extracted media content data and the sensor data.

An example apparatus may include at least one processor and at least one memory storing computer program code, wherein the at least one memory and stored computer program code are configured, with the at least one processor, to cause the apparatus to at least extract media content data and sensor data from a plurality of media content, wherein the sensor data comprises a plurality of data modalities. The at least one memory and stored computer program code are further configured, with the at least one processor, to cause the apparatus to classify the extracted media content data and the sensor data. The at least one memory and stored computer program code are further configured, with the at least one processor, to cause the apparatus to determine an event-type classification based on the classified extracted media content data and the sensor data.

In a further embodiment, a computer program product is provided that includes at least one non-transitory computer-readable storage medium having computer-readable program instructions stored therein, the computer-readable program instructions includes program instructions configured to extract media content data and sensor data from a plurality of media content, wherein the sensor data comprises a plurality of data modalities. The computer-readable program instructions also include program instructions configured to classify the extracted media content data and the sensor data. The computer-readable program instructions also include program instructions configured to determine an event-type classification based on the classified extracted media content data and the sensor data.

One example apparatus may include means for extracting media content data and sensor data from a plurality of media content, wherein the sensor data comprises a plurality of data modalities. The apparatus may also include means for classifying the extracted media content data and the sensor data. The apparatus may further include means for determining an event-type classification based on the classified extracted media content data and the sensor data.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a schematic representation of an example media content event processing system in accordance with an embodiment of the present invention;

FIGS. 2-6 illustrate example scenarios in which the media content event processing systems may be used according to an embodiment of the present invention;

FIG. 7 is an example block diagram of an example computing device for practicing embodiments of a media content event processing system; and

FIG. 8 is an example flowchart illustrating a method of operating an example media content event processing system performed in accordance with an embodiment of the present invention.

### DETAILED DESCRIPTION

Some example embodiments will now be described more fully hereinafter with reference to the accompanying drawings, in which some, but not all embodiments are shown. Indeed, the example embodiments may take many different forms and should not be construed as limited to the embodiments set forth herein; rather, these embodiments are provided so that this disclosure will satisfy applicable legal requirements. Like reference numerals refer to like elements throughout. The terms “data,” “content,” “information,” and similar terms may be used interchangeably, according to some example embodiments, to refer to data capable of being transmitted, received, operated on, and/or stored. Moreover, the term “exemplary”, as may be used herein, is not provided to convey any qualitative assessment, but instead merely to convey an illustration of an example. Thus, use of any such terms should not be taken to limit the spirit and scope of embodiments of the present invention.

As used herein, the term “circuitry” refers to all of the following: (a) hardware-only circuit implementations (such as implementations in only analog and/or digital circuitry); (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term ‘circuitry’ would also cover an implementation of merely a processor (or multiple processors) or portion of a processor and its (or their) accompanying software and/or firmware. The term ‘circuitry’ would also cover, for example and if applicable to the particular claim element, a baseband integrated circuit or application specific integrated circuit for a mobile phone or a similar integrated circuit in a server, a cellular network device, or other network device.

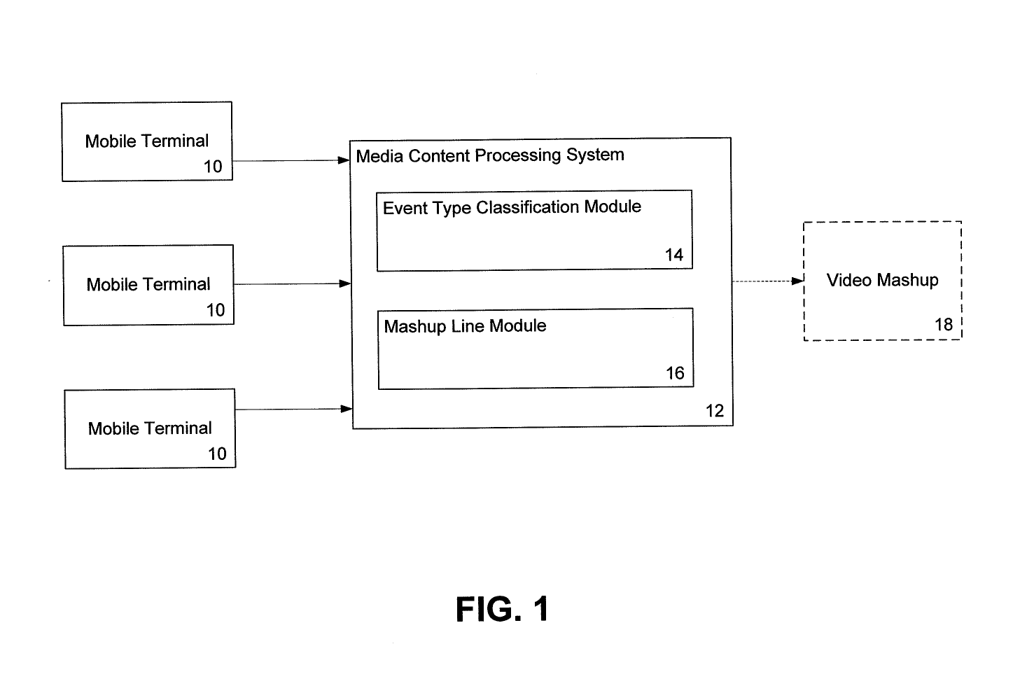

FIG. 1 is a schematic representation of an example media content processing system 12 in accordance with an embodiment of the present invention. In particular the media content processing system 12 may be configured to receive a plurality of media content (e.g. audio records, video segments, photographs and/or the like) from one or more mobile terminals 10. The received media content may be linked, classified and/or somehow associated with a particular public event (e.g. private performance, theater, sporting event, concert and/or the like) and/or the received media content may alternatively be unlabeled or unclassified. The received media content may also include sensor data (e.g. data captured by a visual sensor, an audio sensor, a compass, an accelerometer, a gyroscope or a global positioning system receiver) that was captured at the time the media content were captured, however in some embodiments the sensor data may also be received separately.

In some example embodiments, the mobile terminal 10 may be a mobile communication device such as, for example, a mobile telephone, portable digital assistant (PDA), pager, laptop computer, or any of numerous other hand held or portable communication devices, computation devices, content generation devices, content consumption devices, or combinations thereof. As such, the mobile terminal may include one or more processors that may define processing circuitry either alone or in combination with one or more memories. The processing circuitry may utilize instructions stored in the memory to cause the mobile terminal to operate in a particular way or execute specific functionality when the instructions are executed by the one or more processors. The mobile terminal may also include communication circuitry and corresponding hardware/software to enable communication with other devices and/or the network.

The media content processing system 12 may include an event type classification module 14 and a mashup line module 16. In an embodiment, the event type classification module 14 may be configured to determine an event-type classification of a media content event based on the received media content. In particular, the event type classification module 14 may be configured to determine a layout of the event, a genre of the event and a place of the event. A layout of the event may include determining a type of venue where the event is occurring. In particular, the layout of the event may be classified as circular (e.g. stadium where there are seats surrounding an event) or uni-directional (e.g. proscenium stage). A genre of the event may include a determination of the type of event, for example sports or a musical performance. A place of the event may include a classification identifying whether the place of the event is indoors or outdoors. In some instances a global position system (GPS) lock may also be used. For example in an instance in which a GPS lock was not obtained that may indicate that the mobile terminal captured the media content event indoors.

In an embodiment, the event type classification module 14, may be further configured to utilize multimodal data (e.g. media content and/or sensor data) captured by a mobile terminal 10 during the public event. For example, multimodal data from a plurality of mobile terminals 10 may increase the statistical reliability of the data. Further the event type classification module 14 may also determine more information about an event by analyzing multiple different views captured by the various mobile terminals 10.

The event type classification module 14 may also be configured to extract a set of features from the received data modalities captured by recording devices such as the mobile terminals 10. The extracted features may then be used when the event type classification module 14 conducts a preliminary classification of at least a subset of these features. The results of this preliminary classification may represent additional features, which may be used for classifying the media content with respect to layout, event genre, place and/or the like. In order to determine the layout of an event location, a distribution of the cameras associated with mobile terminals 10 that record the event is determined. Such data enables the event type classification module 14 to determine whether the event is held in a circular like venue such as a stadium or a proscenium stage like venue. In particular, the event type classification module 14 may use the location of the mobile terminals 10 that captured the event to understand the spatial distribution of the mobile terminals 10. The horizontal camera orientations may be used to determine a horizontal point pattern and the vertical camera orientations may be used to determine a vertical camera pointing pattern.

Alternatively or additionally the classification of the type of event and the identification of the mashup line are done in real time or near real time as the data (context and/or media) is continuously received. Each mobile device may be configured to send either the raw sensor data (visual, audio, compass, accelerometer, gyroscope, GPS, etc.) or features that can be extracted from such data regarding the media content recorded by only the considered device, such as average brightness of each recorded media content event, average brightness change rate of each recorded video.

Alternatively or additionally, the classification of the type of event may be partially resolved by each mobile terminal, without the need of uploading or transmitting any data (context or media) other than the final result, and then the collective results are weighted and/or analyzed by the event type classification module 14 for a final decision. In other words the event classification module 14, the mashup line module 16 may located on the mobile terminal 10, or may alternatively be located on a remote server. Therefore each mobile device may perform part of the feature extraction (that does not involve knowledge about data captured by other devices), whereas the analysis of the features extracted by all mobile devices (or a subset of them) is done by the event classification module 14.

Alternatively or additionally, the event classification module 14 performing the analysis for classifying the event type and/or for identifying the mashup line can be one of the mobile terminals present at the event.

The mashup line module 16 is configured to determine a mashup line that identifies the optimal set of cameras to be used for producing a media content event mashup (or remix) 18 (e.g. video combination, compilation, real-time video editing or the like), according to, for example, the “180 degree rule.” A mashup line (e.g. a bisecting line, a 180 degree rule line, or the like) is created in order to ensure that two or more characters, elements, players and/or the like in the same scene maintain the same left/right relationship to each other through the media content event mashup (or remix) even if the final media content event mashup (or remix) is a combination of a number of views captured by a number of mobile terminals. The use of a mashup line enables an audience or viewer of the media content event mashup or remix to visually connect with unseen movements happening around and behind the immediate subject and is important in the narration of battle scenes, sporting events and/or the like.

The mashup line is a line that divides a scene into at least two sides, one side includes those cameras which are used in production of media content event mashup or remix (e.g., a mash-up video where video segments extracted from different cameras are stitched together one after the other, like in professional television broadcasting of football matches, real-time video editing as for performing directing of TV programs or the like), and the other side includes all the other cameras present at the public event.

In an embodiment, the mashup line module 16 is configured to determine the mashup line that allows for the largest number of mobile terminals 10 to be on one side of the mashup line. In order to determine such a mashup line, a main attraction area is determined. The main attraction area is the location or series of locations that the mobile terminal 10 is recording (e.g. center of a concert stage or home plate of a baseball game). In some embodiments, the mashup line intersects the center of the main attraction area mashup line. The mashup line module 16 then considers different rotations of the mashup line and with each rotation the number of mobile terminals 10 on both sides of the line are evaluated. The mashup line module 16 may then choose the optimal mashup line by selecting the line which yields the maximum number of mobile terminals 10 on one of its sides when compared to the other analyzed potential mashup lines.

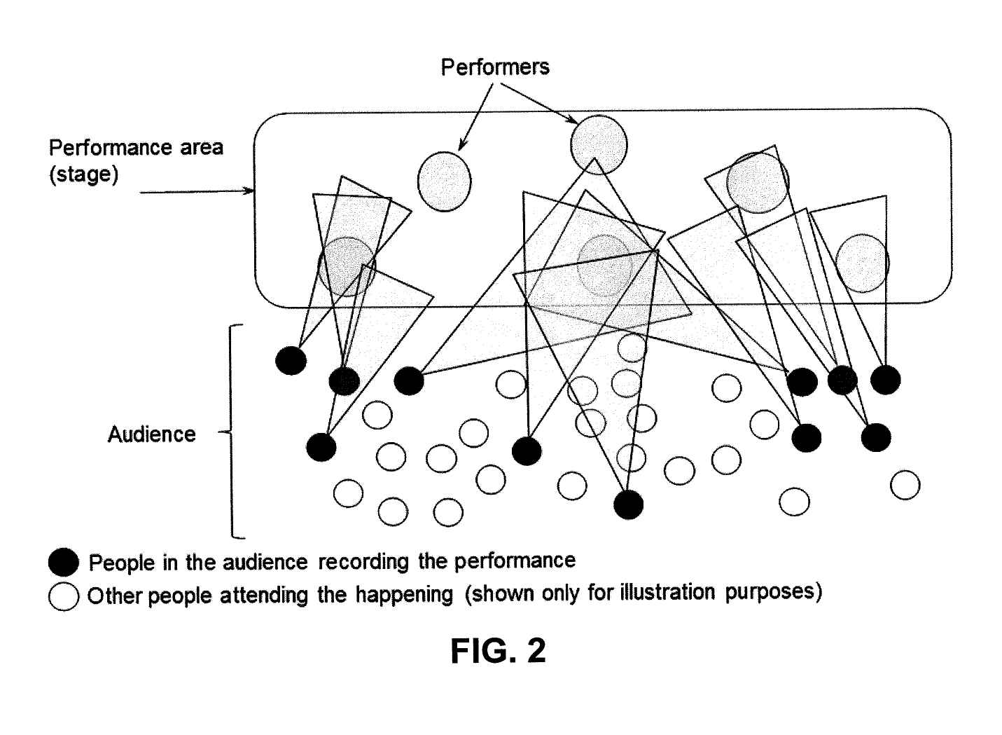

FIGS. 2-6 illustrate example scenarios in which the media content event processing systems, such as media content processing system 12 of FIG. 1, may be used according to an embodiment of the present invention. For example, FIG. 2 illustrates a performance stage with viewers on one side (e.g. a proscenium stage). In this example, there are a number of performers that may be captured by users in the audience using mobile terminals. As is shown by FIG. 2, a number of different views of the event may be captured and using systems and methods herein, these views may be combined in a mashup or remix.

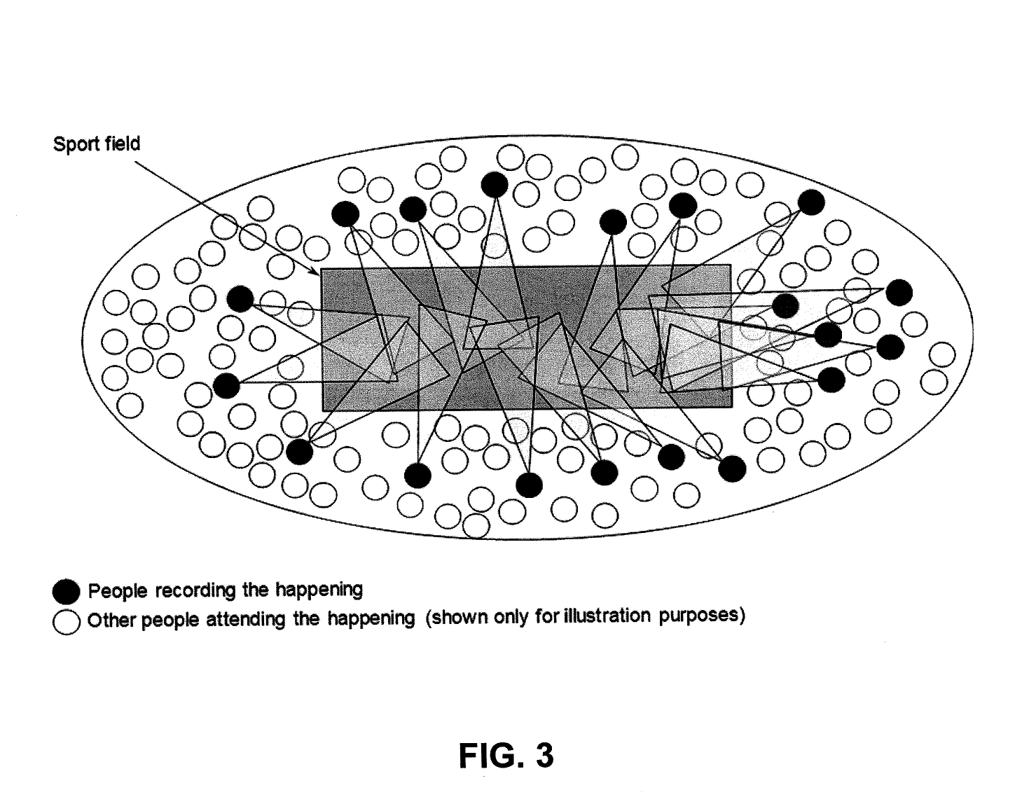

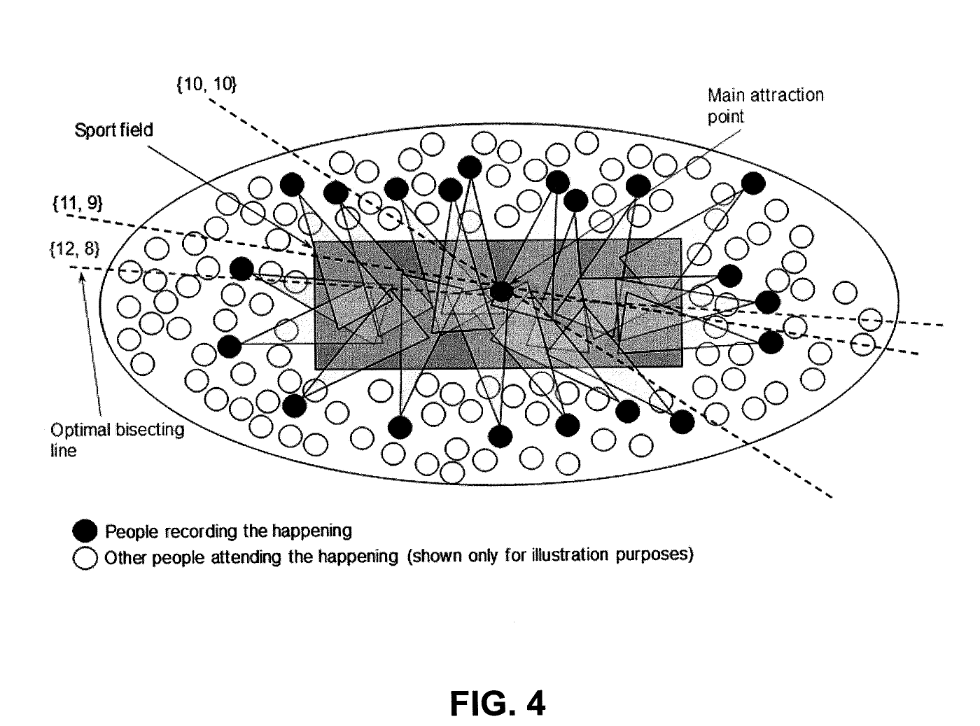

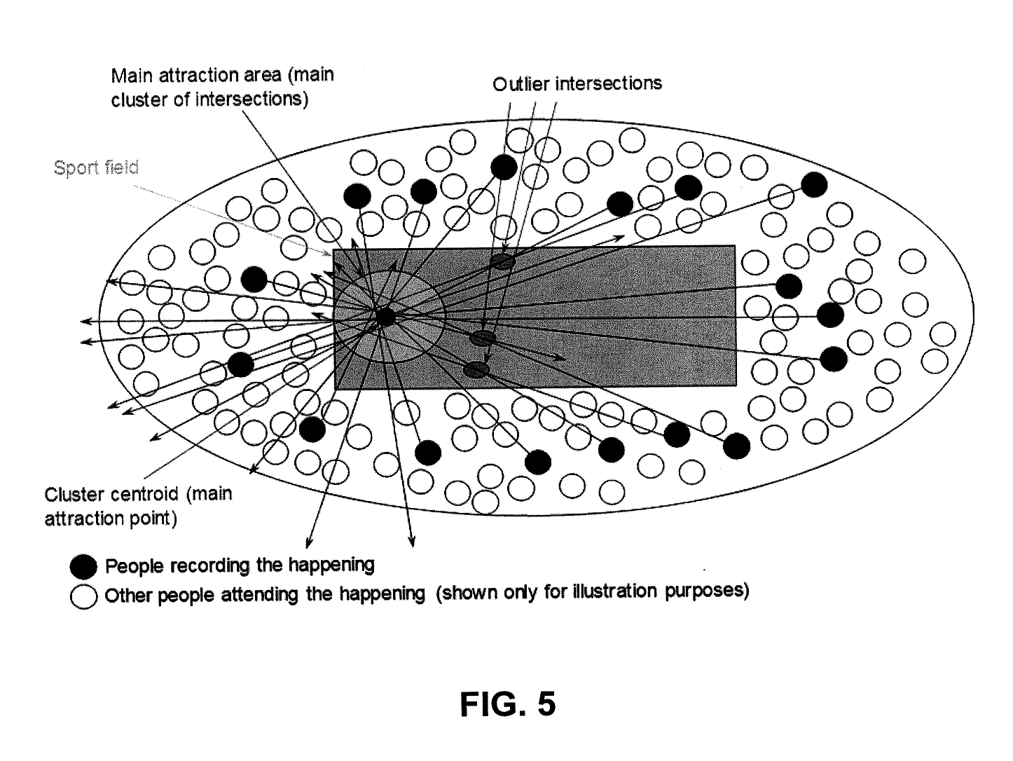

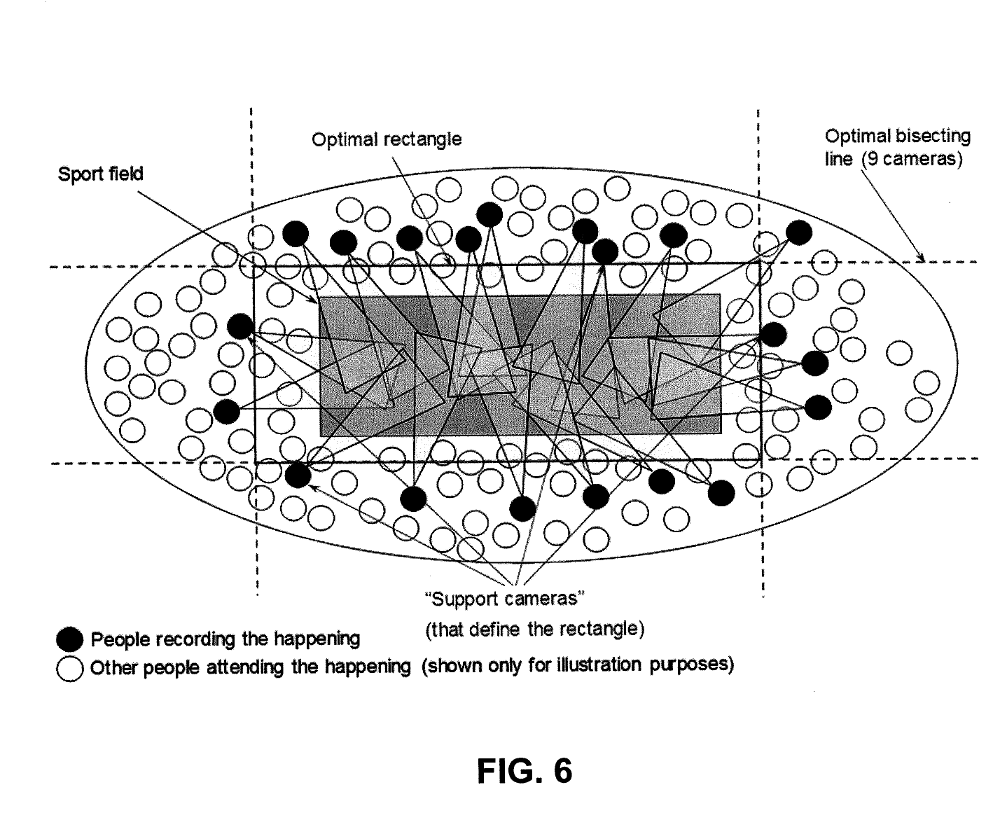

FIG. 3 illustrates an example of a plurality of viewers capturing an example event on a rectangular sporting field from multiple angles in a generally circularly stadium. FIG. 4 illustrates a similar example sports stadium and identifies an example main attraction point and example mashup lines. An example optimal mashup line is also shown that identifies 12 users on one side of the line. FIG. 5 illustrates an example main attraction area that is chosen based on a main cluster of interactions. FIG. 6 illustrates an optimal mashup line using an optimal rectangle according to an alternate embodiment of the present invention. As is shown in FIG. 6, the mashup lines are aligned with the general shape of the field and then a mashup line is chosen using similar means as described above.

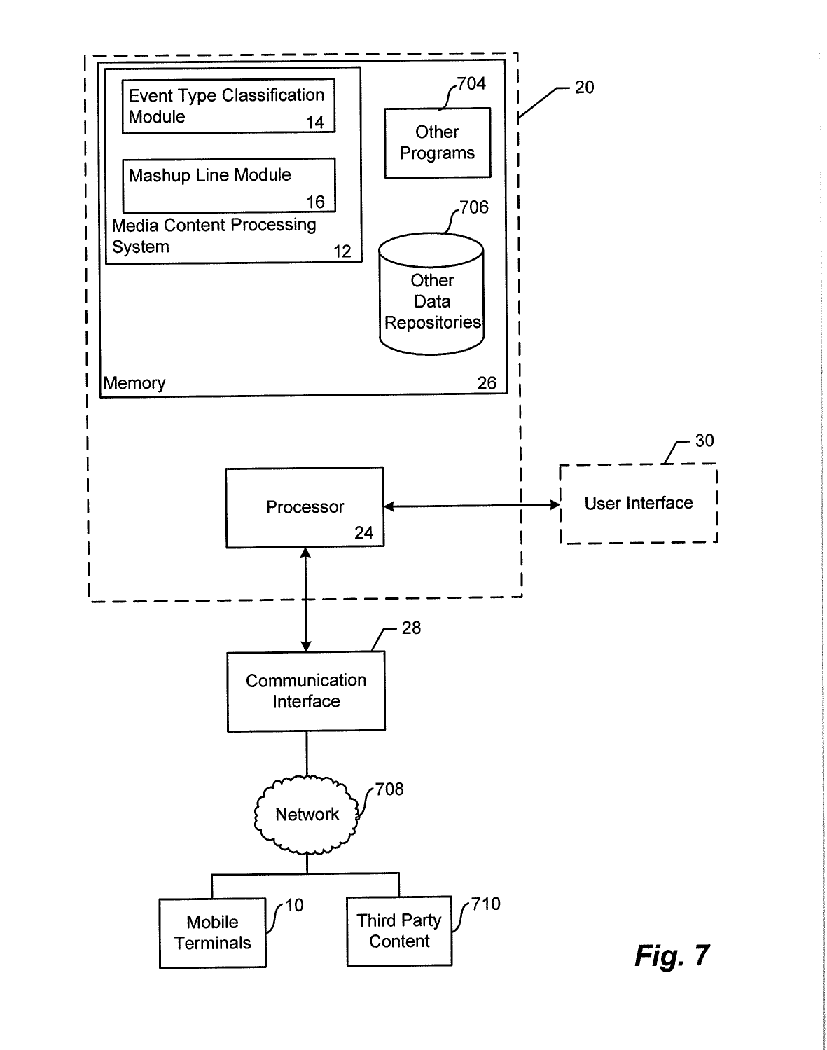

FIG. 7 is an example block diagram of an example computing device for practicing embodiments of a media content event processing system. In particular, FIG. 7 shows a system 20 that may be utilized to implement a media content processing system 12. Note that one or more general purpose or special purpose computing systems/devices may be used to implement the media content processing system 12. In addition, the system 20 may comprise one or more distinct computing systems/devices and may span distributed locations. Furthermore, each block shown may represent one or more such blocks as appropriate to a specific embodiment or may be combined with other blocks. For example, in some embodiments the system 20 may contain an event type classification module 14, a mashup line module 16 or both. In other example embodiments, the event type classification module 14 and the mashup line module 16 may be configured to operate on separate systems (e.g. a mobile terminal and a remote server, multiple remote servers and/or the like). For example, the event type classification module 14 and/or the mashup line module 16 may be configured to operate on a mobile terminal 10. Also, the media content processing system 12 may be implemented in software, hardware, firmware, or in some combination to achieve the capabilities described herein.

While the system 20 may be employed, for example, by a mobile terminal 10, stand-alone system (e.g. remote server), it should be noted that the components, devices or elements described below may not be mandatory and thus some may be omitted in certain embodiments. Additionally, some embodiments may include further or different components, devices or elements beyond those shown and described herein.

In the embodiment shown, system 20 comprises a computer memory (“memory”) 26, one or more processors 24 (e.g. processing circuitry) and a communications interface 28. The media content processing system 12 is shown residing in memory 26. In other embodiments, some portion of the contents, some or all of the components of the media content processing system 12 may be stored on and/or transmitted over other computer-readable media. The components of the media content processing system 12 preferably execute on one or more processors 24 and are configured to extract and classify the media content. Other code or programs 704 (e.g., an administrative interface, a Web server, and the like) and potentially other data repositories, such as data repository 706, also reside in the memory 26, and preferably execute on processor 24. Of note, one or more of the components in FIG. 7 may not be present in any specific implementation.

In a typical embodiment, as described above, the media content processing system 12 may include an event type classification module 14, a mashup line module 16 and/or both. The event type classification module 14 and a mashup line module 16 may perform functions such as those outlined in FIG. 1. The media content processing system 12 interacts via the network 708 via a communications interface 28 with (1) mobile terminals 10 and/or (2) with third-party content 710. The network 708 may be any combination of media (e.g., twisted pair, coaxial, fiber optic, radio frequency), hardware (e.g., routers, switches, repeaters, transceivers), and protocols (e.g., TCP/IP, UDP, Ethernet, Wi-Fi, WiMAX) that facilitate communication between remotely situated humans and/or devices. In this regard, the communications interface 28 may be capable of operating with one or more air interface standards, communication protocols, modulation types, access types, and/or the like. More particularly, the system 20, the communications interface 28 or the like may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (e.g., session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

In an example embodiment, components/modules of the media content processing system 12 may be implemented using standard programming techniques. For example, the media content processing system 12 may be implemented as a “native” executable running on the processor 24, along with one or more static or dynamic libraries. In other embodiments, the media content processing system 12 may be implemented as instructions processed by a virtual machine that executes as one of the other programs 704. In general, a range of programming languages known in the art may be employed for implementing such example embodiments, including representative implementations of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), and declarative (e.g., SQL, Prolog, and the like).

The embodiments described above may also use either well-known or proprietary synchronous or asynchronous client-server computing techniques. Also, the various components may be implemented using more monolithic programming techniques, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs. Some embodiments may execute concurrently and asynchronously, and communicate using message passing techniques. Equivalent synchronous embodiments are also supported. Also, other functions could be implemented and/or performed by each component/module, and in different orders, and by different components/modules, yet still achieve the described functions.

In addition, programming interfaces to the data stored as part of the media content processing system 12, can be made available by standard mechanisms such as through C, C++, C#, and Java APIs; libraries for accessing files, databases, or other data repositories; through languages such as XML; or through Web servers, FTP servers, or other types of servers providing access to stored data. A data store may also be included and it may be implemented as one or more database systems, file systems, or any other technique for storing such information, or any combination of the above, including implementations using distributed computing techniques.

Different configurations and locations of programs and data are contemplated for use with techniques described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, and the like). Other variations are possible. Also, other functionality could be provided by each component/module, or existing functionality could be distributed amongst the components/modules in different ways, yet still achieve the functions described herein.

Furthermore, in some embodiments, some or all of the components of the media content processing system 12 may be implemented or provided in other manners, such as at least partially in firmware and/or hardware, including, but not limited to one or more application-specific integrated circuits (“ASICs”), standard integrated circuits, controllers executing appropriate instructions, and including microcontrollers and/or embedded controllers, field-programmable gate arrays (“FPGAs”), complex programmable logic devices (“CPLDs”), and the like. Some or all of the system components and/or data structures may also be stored as contents (e.g., as executable or other machine-readable software instructions or structured data) on a computer-readable medium (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

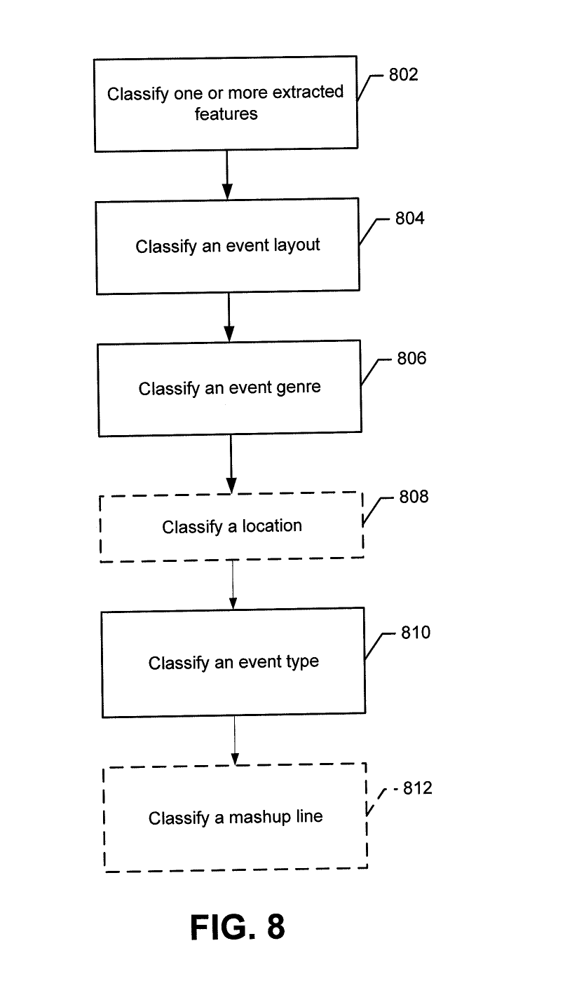

FIG. 8 illustrates an example flowchart of the example operations performed by a method, apparatus and computer program product in accordance with an embodiment of the present invention. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory 26 of an apparatus employing an embodiment of the present invention and executed by a processor 24 in the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowchart block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s). As such, the operations of FIG. 8, when executed, convert a computer or processing circuitry into a particular machine configured to perform an example embodiment of the present invention. Accordingly, the operations of FIG. 8 define an algorithm for configuring a computer or processing to perform an example embodiment. In some cases, a general purpose computer may be provided with an instance of the processor which performs the algorithms of FIG. 8 to transform the general purpose computer into a particular machine configured to perform an example embodiment.

Accordingly, blocks of the flowchart support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations herein may be modified or further amplified as described below. Moreover, in some embodiments additional optional operations may also be included. It should be appreciated that each of the modifications, optional additions or amplifications below may be included with the operations above either alone or in combination with any others among the features described herein.

FIG. 8 is an example flowchart illustrating a method of operating an example media content event processing system performed in accordance with an embodiment of the present invention. As is described herein, the systems and methods of the media processing system may be configured to analyze media content captured by a camera of a public event. As shown in operation 802, the system 20 may include means, such as the media content processing system 12, the event type classification module 14, the processor 24 or the like for classifying one or more extracted features, wherein the features are extracted from the media content event. The event type classification module 14, the processor 24 or the like may be configured to extract features from the media content event such as the content data and/or the sensor data. For example, these extracted features may be classified as low or high. For example the features may be grouped into different categories before classification, such as but not limited to: visual data, audio data, compass data, accelerometer data, gyroscope data, GPS receiver data and/or the like.

The event type classification module 14, the processor 24 or the like may be configured to group and classify the extracted features. For example the extracted video data may be classified according to the brightness and/or color of the visual data. The brightness category may be classified, for example, into a level of average brightness, over some or all the media content (low vs. high) and/or a level of average brightness change rate over some or all media content (low vs. high). The color category may be classified by, for example, a level of average occurrence of green (or other color, such as brown or blue—The specific dominant color(s) to be considered may be given as an input parameter, based on what kind of sports it is expected to be covered) as the dominant color (low vs. high) over some or all media content and/or a level of average dominant color change rate (low vs. high). The audio data category may be classified by, for example, average audio class, over some or all media content (no-music vs. music) and/or average audio similarity, over some or all media content event pairs (low vs. high). The compass data category may be classified by, for example, instantaneous horizontal camera orientations for each media content event, average horizontal camera orientation for each media content event, and/or average camera panning rate, over some or all media content (low vs. high). The accelerometer, gyroscope, or the like data category may be classified by, for example, average camera tilt angle for each media content event and/or average camera tilting rate, over some or all media content (low vs. high). The GPS receiver data category may be classified by, for example, averaged GPS coordinates, for each media content event and/or average lock status, over some or all videos (no vs. yes). Additional or alternative classifications may be used in alternate embodiments.

In an embodiment, the event type classification module 14, the processor 24 or the like may determine a brightness of the media content. Brightness may also be used to classify a media content event. For example, a brightness value may be lower for live music performances (e.g. held at evening or night) than for sporting events (e.g. held in daytime or under bright lights). The determined brightness value may be determined for a single frame and then may be compared with a predetermined threshold to determine a low or high brightness classification. Alternatively or additionally, a weighted average of the brightness may be computed by the event type classification module 14, the processor 24 or the like from some or all media content where the weights are, in an embodiment, the length of each media content event.

In an embodiment, the event type classification module 14, the processor 24 or the like may determine an average brightness change rate, which represents a change of brightness level (e.g. low or high) over subsequent media content event frames. Each media content event may be characterized by a brightness change rate value and a weighted average of the values is obtained from some or all media content, where the weight, in one embodiment, may be a media content event length. The brightness change rate value may, for example, suggest a live music show in instances in which brightness changes quickly (e.g. different usage of lights).

In an embodiment, the event type classification module 14, the processor 24 or the like may extract dominant colors from one or more frames of media content and then the most dominant color in the selected frame may be determined. The event type classification module 14, the processor 24 or the like may then be configured to obtain an average dominant color over some or all frames for some or all media content. A weighted average of all average dominant colors of the media content may be determined by, in an embodiment, the media content event lengths. For example, in an instance in which the dominant color is green, brown or blue then the media content event may represent a sporting event. Other examples include a brown as the dominant color of clay court tennis and/or the like.

The event type classification module 14, the processor 24 or the like may be configured to extract a dominant color for each frame in a media content event to determine a dominant color change rate. A weighted average of the rates over some or all media content may then be determined, and, in an embodiment, a weight may be a media content event length. The event type classification module 14, the processor 24 or the like may then compare the weighted average rate to a predefined threshold to classify the level of average dominant colors change rate (low or high).

In an embodiment, the event type classification module 14, the processor 24 or the like may extract and/or determine the change rate for average brightness and/or the dominant color based on a sampling period, such as a number of frames or a known time interval. The rate of sampling may be predetermined and/or based on an interval, a length and/or the like. Alternatively or additionally, one rate may be calculated for each media content event. Alternatively or additionally, for each media content, several sampling rates for analyzing the change in brightness or in dominant colors may be considered; in this way, for each media content event, several change rates (one for each considered sampling rate) will be computed; the final change rate for each media content event is the average of the change rates obtained for that media content using different sampling rates. By using this technique based on several sampling rates, an analysis of the change rate at different granularity levels may be achieved.

In an embodiment, the event type classification module 14, the processor 24 or the like may utilize audio data to determine an audio classification for categorizing audio content, for example music or no-music. In particular, a dominant audio class may be determined for each media content event. A weighted average may then be determined for a dominant audio class for some or all media content, where, in an embodiment, the weights may be the length of the media content. An audio similarity may also be determined between audio tracks of different media content captured at similar times of the same event. An average of the audio similarity over some or all media content event pairs may be determined and the obtained average audio similarity may be compared with a predefined threshold to determine a classification (e.g. high or low).

In an embodiment, the event type classification module 14, the processor 24 or the like may analyze data provided by an electronic compass (e.g. obtained via a magnetometer) to determine the orientation of a camera or other image capturing device while a media content event was recorded. In some embodiments, media content event data and compass data may be simultaneously stored and/or captured. An instantaneous horizontal camera orientation as well as an average horizontal camera orientation may be extracted throughout the length of each video.

In an embodiment, the event type classification module 14, the processor 24 or the like may utilize average camera orientations received from a plurality of mobile terminals that recorded and/or captured media content of the public event to determine how users and mobile terminals are spread within an area. Such a determination may be used to estimate a pattern of camera orientations at the event. See for example FIGS. 2 and 3.

Alternatively or additionally, compass data may also be used to determine the rate of camera panning movements. Gyroscope data may be also used to determine a rate of camera panning movements. In particular, a camera panning rate may be determined for each user based on compass data captured during the camera motion. Then, for each media content event, a rate of camera panning may then be computed. A weighted average of the panning rates for some or all media content may be determined, where the weight may be, in an embodiment, the length of the media content event. The weighted average may then be compared to a predetermined threshold to determine whether the average panning rate is for example low or high. By way of example, in a sporting event a panning rate may be higher than in a live music show.

In an embodiment, the event type classification module 14, the processor 24 or the like may utilize accelerometer sensor data or gyroscope data to determine an average camera tilt angle (e.g. the average vertical camera orientation). The rate of camera tilt movements may be computed by analyzing accelerometer or gyroscope data captured during a recording of a media content event. A weighted average of the tilt rates for some or all media content may be determined using, in an embodiment, the media content event lengths as a weight value. The obtained weighted average of the tilt rates of the videos may be compared with a predefined threshold to classify the tilt rate as low or high. By way of example, low tilt rates are common during the recording of live music events whereas high tilt rates are more common for sporting events.

In an embodiment, the event type classification module 14, the processor 24 or the like may determine a GPS lock status (e.g. the ability of a GPS receiver in a mobile terminal to determine a position using signal messages from a satellite) for each camera that is related to the generation of a media content event. An average GPS lock status may be computed for some or all cameras. Instantaneous GPS coordinates may be extracted for each media content event and may be calculated for the duration of a media content event.

As shown in operation 804, the system 20 may include means, such as the media content processing system 12, the event type classification module 14, the processor 24 or the like for classifying an event layout. An event may be classified into classes such as circular and/or uni-directional. In order to determine a layout classifier, the event type classification module 14, the processor 24 or the like may determine average location coordinates and the average orientation of a camera that captured a media content event (e.g. horizontal and vertical orientations). Average location coordinates may then be used to estimate a spatial distribution of the cameras that captured a media content event.

In an embodiment, to estimate whether the determined locations fit a circular or elliptical shape, mathematical optimization algorithms may be used to select parameters of an ellipse that best fits the known camera locations. Based on the determined parameters, an average deviation is determined and in an instance in which the average deviation is less than a predetermined threshold, then the camera locations are classified as belonging to an ellipse. Alternatively or additionally, camera locations may be mapped onto a digital map that may be coupled with metadata about urban information (e.g. a geographic information system) in order to understand if the event is held in a location corresponding to the location of, for example, a stadium.

In an embodiment, the average horizontal orientations of each camera may be used by the event type classification module 14, the processor 24 or the like to estimate how the cameras that captured the media content event were horizontally oriented, either circularly or directionally. The horizontal orientation of the camera may also be output by an electronic compass.

Alternatively or additionally, the average vertical orientations of each camera may also be used to estimate how a camera was vertically oriented. In particular and for example, if most of the cameras are determined to be tilted downwards based on their vertical orientations, then the vertical orientation features will indicate a circular layout, as most common circular types of venue for public events are stadiums with elevated seating. Instead, if most of the cameras are tilted upwards, the event layout may be determined to be uni-directional because most spectators may be at a level equal to or less than the stage.

In an embodiment, the tilt angle of a mobile terminal may be estimated by analyzing the data captured by an embedded accelerometer, gyroscope or the like. Average camera locations, presence of a stadium in the corresponding location on a digital map, and average orientations (horizontal and vertical) contribute to determining whether the layout of the event is circular or uni-directional (e.g. a proscenium type stage). The event layout decision may be based on a weighted average of the classification results provided by camera locations and orientations. If any of the features used for layout classification are missing, the available features are simply then used for the analysis. For example, in an instance in which the location coordinates are not available (e.g., if the event is held indoor and GPS positioning system is used), only the orientations are used for the final decision on the layout. The weights can be chosen either manually or through an example supervised learning approach.

As shown in operation 806, the system 20 may include means, such as the media content processing system 12, the event type classification module 14, the processor 24 or the like for classifying an event genre. To classify a genre, the following non-exhaustive list of input features may be used: level of occurrence of green (or other colors such as but not limited to brown or blue) as the dominant color; average dominant color change rate; level of average brightness; average brightness change rate; audio class; camera panning rate; camera tilting rate and/or audio similarity. By way of example, a genre may be classified as a sports genre in instance in which one or more of the following occurred: high level of occurrence of green (or brown or blue) as dominant color; low average dominant color change rate; high level of average brightness; low level of average brightness change rate; audio class being “no music”; high level of panning rate; and/or high level of tilting rate.

In an embodiment, the event type classification module 14, the processor 24 or the like may analyze audio similarity features in an instance in which a circular layout has been detected in operation 804. In some instances a stadium may be configured to hold either a sporting event or a live music event. For example, if the genre is a sporting event, there may not be a common audio scene, however in live music shows the stadium may contain loudspeakers which output the same audio content, thus the system and method as described herein may determine a common audio scene even for cameras attached to mobile terminals positioned throughout the stadium. Therefore, in this example, a high level of average audio similarity may mean that the event genre is a live music event, otherwise a sport event.

In an embodiment, any suitable classification approach can be applied to the proposed features for achieving the final decision on the event genre. One example may weight one feature over another and/or may use linear weighted fusion. Alternatively or additionally, the specific values for the weights can be set either manually (depending on how relevant, in terms of discriminative power, the feature is in the genre classification problem) or through a supervised learning approach.

As shown in operation 808, the system 20 may include means, such as the media content processing system 12, the event type classification module 14, the processor 24 or the like for classifying a location. For example, if the average GPS lock status is “yes” (e.g., in lock), then it is more likely the recording occurring outdoor. Otherwise it may be concluded, when the average GPS lock status is “no,” that the recording took place indoors.

As shown in operation 810, the system 20 may include means, such as the media content processing system 12, the event type classification module 14, the processor 24 or the like for classifying a location. In order to determine the type of event, the event type classification module may input the layout information (circular vs. directional), the event genre (sport vs. live music), and the place (indoor vs. outdoor). By combining these inputs, the event type classification module 14, the processor 24 or the like may classify the type of event as one of the following descriptions (e.g. a “proscenium stage” is the most common form of music performance stage, where the audience is located on one side of the stage): sport, outdoor, in a stadium; sport, outdoor, not in a stadium; sport, indoor, in a stadium; sport, indoor, not in a stadium; live music, outdoor, in a stadium; live music, outdoor, in a proscenium stage; live music, indoor, in a stadium; live music, indoor, in a proscenium stage. Alternatively or additionally, the event type classification module 14 may be configured to classify an event by means of supervised learning, for example by using the proposed features extracted from media content with a known genre. A classification then may be performed on unknown data by using the previously trained event type classification module 14. For instance, Decision Trees or Support Vector Machines may be used.

In an instance in which the identified layout is stadium and the event is held outdoors (thus GPS data is available) or, alternatively, the event is held indoors and an indoor positioning system is available, the mashup line module 16, the processor 24 or the like may estimate an optimal mashup line by analyzing the relative positions of the cameras. See operation 812. For example as is shown with reference to FIG. 3, an optimal mashup line may be determined based on a determined main attraction point of the camera positions (e.g. focal point of some or all recorded media content). A line that intersects the main attraction point may represent a candidate mashup line. The mashup line module 16, the processor 24 or the like may then rotate candidate mashup lines progressively, and at each orientation the number of cameras lying on each of the two sides of the line may be counted. Thus, for each candidate mashup line (e.g., for each orientation), the side with maximum number of cameras may be considered. After some or all the orientations have been considered, the mashup line that has the maximum number of cameras on one of the two sides, over some or all the candidate mashup lines may then be chosen.

The main attraction point, which is intersected by the candidate mashup lines, may be determined by the bisection line module 16 in various ways. For example, the locations and the horizontal orientations of some or all the cameras (see e.g. FIG. 4) may be used. For each instant (or for each segment of predefined duration), the media content (and associated sensor data) that has been captured at that particular instant (or at the closest sampling instant) may be analyzed. For each overlapping media content event one video frame, one camera orientation, one camera position may then be considered for purposes of determining the main attraction point mashup line. By means of geometric calculations on the available camera positions and orientations, the spatial coordinates of the points in which any two camera directions intersect may be calculated. As a result a set of intersecting points may be obtained. In an embodiment, the intersecting points are obtained by solving a system of two linear equations for each pair of cameras, where each linear equation describes the pointing direction of a camera. Such an equation can be expressed in the “point-slope form”, where the point is the camera location and the slope is given by the horizontal camera orientation (e.g. derived from the compass data). Each of the intersecting points may then be analyzed by the mashup line module 16 in order to find the cluster of such points that is the densest, such that outlier intersection points are excluded from this most dense cluster. For achieving this, any suitable clustering algorithm may be applied to the intersection points. The densest cluster represents a main attraction area for the camera users for the considered instant or temporal segment, such as a frame or a series of frames. For example, obtaining the densest cluster may consist of applying a robust mean (such as alpha-trimmed mean) across each of the spatial dimensions. From the found cluster of intersections, a representative point may be considered, which can be for example the cluster centroid. Such a point may be the instantaneous main attraction point, e.g., it is relative to the instant or temporal segment considered for estimating it. The final choice for the main attraction point is derived from some or all the instantaneous attraction points, for example by averaging their spatial coordinates. The final main attraction point is the point intersected by the candidate mashup lines. The attraction point (either an instantaneous attraction point or a final attraction point one determined from a plurality of determined instantaneous points) can be used also for computing the distance between each mobile terminal (for which location information is available) and this attraction point.

Alternatively or additionally, as shown in FIG. 5, it may be optimal to include cameras mainly from a longest side of the playing such as a long side of a rectangle. The mashup line module 16 is there configured to determine a rectangle that is sized to fit within the circular pattern of the cameras and the four sides of the rectangle may be determined by support cameras. The area of the rectangle may be maximized with respect to different orientations of potential rectangles. Once the rectangle is determined, side lines of the rectangle may be used as candidate mashup lines. Thus each line is evaluated by a determined number of cameras along the side of the rectangle and an optimal mashup line is determined based on the mashup line with the largest number of cameras on the external side.

Advantageously, the media content processing system 12 may then be configured to generate a mashup or remix of media content that were recorded by multiple cameras in multiple mobile terminals. Such a mashup (or remix), for example, may be constructed for a circular event without causing the viewer of the mashup or remix to become disoriented.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
extracting media content data and sensor data from a plurality of media content, wherein the sensor data comprises a plurality of data modalities;
classifying the extracted media content data and the sensor data; and
determining an event-type classification based on the classified extracted media content data and the sensor data.

2. A method of claim 1 further comprises:
determining a layout of the determined event-type classification;
determining an event genre of the determined event-type classification; and
determining an event location of the determined event-type classification, wherein the event location comprises at least one of indoor or outdoor.

3. A method of claim 2 further comprising:
receiving at least one of a determined layout, a determined event genre or an event location from at least one mobile terminal.

4. A method of claim 2 wherein determining the layout further comprises:
determining a spatial distribution of a plurality of cameras that caused the recording of the media content;
determining a horizontal camera pointing pattern and a vertical camera pointing pattern; and
determining the layout of the determined event type classification.

5. A method of claim 2 wherein determining the event genre further comprises:
determining at least one of average brightness, average brightness change rate, average dominant color, average dominant color change rate, average panning rate, average tilting rate, average audio class, average audio similarity level; and
classifying the event genre, wherein the event genre is at least one of a sport genre or a live music genre.

6. A method of claim 2 wherein determining the event location further comprises:
determining a global positioning system (GPS) lock status for one or more mobile terminals that captured media content data;
in an instance in which a number of mobile terminals that have a determined global position system lock status which exceeds a predetermined threshold then determining the event location as outdoors; and
in an instance in which a number of mobile terminals that have a determined global position system lock status which does not exceed the predetermined threshold then determining the event location as indoors.

7. A method of claim 1 further comprises determining a mashup line for the plurality of media content.

8. A method of claim 7, wherein determining a mashup line further comprises:
determining a main attraction point of the determined event based on a plurality of cameras that captured the plurality of media content; and
determining the mashup line that intersects the determined main attraction point and that results in the maximum number of cameras on a side of the determined mashup line.

9. A method of claim 8, wherein determining a mashup line further comprises:
determining a field shape based on the classified media content data and the sensor data;
determining a rectangle that is maximized based on the field shape;
determining a number of cameras that captured the plurality of media content that are on an external side of the determined rectangle; and
determining the mashup line that results in the maximum number of cameras on the determined external side of the rectangle.

10. A method of claim 9 further comprising:
receiving at least one of a determined field shape, rectangle, number of cameras or mashup line from at least one mobile terminal.

11. A method of claim 1, wherein the sensor data is obtained from at least one of a visual sensor, an audio sensor, a compass, an accelerometer, a gyroscope or a global positioning system receiver.

12. A method of claim 1 further comprises determining a type of event in real time.

13. A method of claim 1 further comprises determining a mashup line in real time.

14. A method of claim 1 further comprises determining a type of event based on received events types classified by a mobile terminal based on captured media content.

15. An apparatus comprising:
a processor and
a memory including software, the memory and the software configured to, with the processor, cause the apparatus to at least:
extract media content data and sensor data from a plurality of media content, wherein the sensor data comprises a plurality of data modalities;
classify the extracted media content data and the sensor data; and
determine an event-type classification based on the classified extracted media content data and the sensor data.

16. An apparatus of claim 15 wherein the at least one memory including the computer program code is further configured to, with the at least one processor, cause the apparatus to:
determine a layout of the determined event-type classification;
determine an event genre of the determined event-type classification; and
determine an event location of the determined event-type classification, wherein the event location comprises at least one of indoor or outdoor.

17. An apparatus of claim 16 wherein the at least one memory including the computer program code is further configured to, with the at least one processor, cause the apparatus to:
determine a layout a plurality of cameras that caused the recording of the media content;
determine a horizontal camera pointing pattern and a vertical camera pointing pattern; and
determine the layout of the determined event type classification.

18. An apparatus of claim 15 wherein the at least one memory including the computer program code is further configured to, with the at least one processor, cause the apparatus to determine a mashup line for the plurality of media content.

19. An apparatus of claim 18, wherein the at least one memory including the computer program code is further configured to, with the at least one processor, cause the apparatus to:
determine a main attraction point of the determined event based on a plurality of cameras that captured the plurality of media content; and
determine the mashup line that results in the maximum number of cameras on a side of the determined mashup line.

20. An apparatus of claim 19, wherein the at least one memory including the computer program code is further configured to, with the at least one processor, cause the apparatus to:
determine a field shape based on the classified media content data and the sensor data;
determine a rectangle that is maximized based on the field shape;
determine a number of cameras that captured the plurality of media content that are on a side of the determined rectangle; and
determine the mashup line that results in the maximum number of cameras on the determined side of the rectangle.
